(19) United States
(12) Patent Application Publication
(10) Pub. No.: US 2008/0198803 A1
(43) Pub. Date: Aug. 21, 2008

(54) Apparatus and method for retransmitting data in a wireless communication system

(75) Inventors: Sang-Min Lee, Seoul (KR); Young-Ho Jung, Suwon-si (KR); Myeon-Kyun Cho, Seongnam-si (KR); Dong-Ho Kim, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/070,102

(22) Filed: Feb. 15, 2008

(30) Foreign Application Priority Data
Feb. 15, 2007 (KR) 2007-0015708

(51) Int. Cl. H04Q 7/00

(52) U.S. Cl. 370/329

(57) ABSTRACT

A retransmission apparatus and method in a wireless communication system are provided, in which it is determined whether a retransmission signal exists, when channels for transmitting signals are changed to new channels, a channel is allocated to the retransmission signal, taking into account state information about the new channels, when the retransmission signal exists, and the retransmission signal is transmitted on the allocated channel.

### CROSS-REFERENCE TO RELATED APPLICATION(S) AND CLAIM OF PRIORITY

This application claims the benefit under 35 U.S.C. §119 (a) of a Korean Patent Application filed in the Korean Intellectual Property Office on Feb. 15, 2007 and assigned Serial No. 2007-15708, the entire disclosure of which is hereby incorporated by reference.

### TECHNICAL FIELD OF THE INVENTION

The present invention generally relates to an apparatus and method for performing Automatic Repeat reQuest (ARQ). More particularly, the present invention relates to an apparatus and method for allocating a channel to deliver a retransmission packet in a wireless communication system.

### BACKGROUND OF THE INVENTION

Data may have errors according to the channel state of radio resources in a wireless communication system. The wireless communication system can correct or control the errors using ARQ and Forward Error Correction (FEC).

A receiver corrects errors in data in FEC. In ARQ, the receiver requests a retransmission of the erroneous data to a transmitter. That is, the receiver transmits the error check result (e.g., a Cyclic Redundancy Check (CRC) check result) of a received packet to the transmitter. If the packet has no errors, the receiver transmits an ACKnowledgment (ACK) signal to the transmitter. If the packet has errors, the receiver transmits a Negative ACK (NACK) signal to the transmitter.

Upon receipt of the ACK signal, the transmitter transmits a new original packet. On the other hand, upon receipt of the NACK signal, the transmitter retransmits the packet.

For reliable data transmission, the wireless communication system adopts Medium Access Control (MAC) ARQ that takes place in the MACY layer and Hybrid ARQ (HARQ) that is performed in the physical layer. For example, the transmitter is configured as illustrated in FIG. 1, for HARQ.

FIG. 1 is a block diagram of a retransmission apparatus in a conventional wireless communication system.

Referring to FIG. 1, the transmitter includes processor groups 100, a Parallel-to-Serial (P/S) converter unit 110, a channel allocator 120, and a channel state checker 130.

Each processor group 100 has HARQ processors for handling transmission or retransmission of packets received from a higher layer according to the packet transmission timing of the processor group 100.

Upon receipt of an ACK signal from a receiver, an HARQ processor processes a new original packet received from the higher layer, for transmission to the receiver at the packet transmission timing of the processor group 100 to which the HARQ processor belongs. Upon receipt of a NACK signal from the receiver, the HARQ processor processes an erroneous packet corresponding to the NACK signal to be retransmitted to the receiver.

The P/S converter unit 110 converts packets received from HARQ processors of the processor groups 100 to serial signals. For example, a first P/S converter serializes packets received from a first HARQ processor of a first processor group (processor group 1) and a first HARQ processor of a second processor group (processor group 2).

The channel allocator 120 allocates packets received from the P/S converter unit 110 to channels selected according to channel information received from the channel state checker 130.

The channel state checker 130 checks channel information between the transmitter and receivers and provides the channel information to the channel allocator 120. For example, the channel information can be checked from Channel Information Indications (CQIs) fed back from the receivers.

As described above, the transmitter transmits packets on channels selected by the channel allocator 120. As to packet retransmission, the transmitter retransmits a packet at the same transmission timing on the same channel as the original version of the packet.

However, if the channel that has delivered the original packet is changed, the transmitter randomly allocates a channel for the retransmission packet and sets the transmission timing of the retransmission packet to that of the original packet.

In this case, performance may be degraded because the transmitter allocates the channel for the retransmission packet with no regard to channel quality. For example, the transmitter retransmits the packet using the same Modulation and Coding Scheme (MCS) level as that of the original packet. Therefore, if the MCS level of the random channel allocated for the retransmission packet is different from that of the retransmission packet, the retransmission packet has an increased error rate or a decreased data rate.

### SUMMARY OF THE INVENTION

To address the above-discussed deficiencies of the prior art, it is a primary object of the present invention to address at least the problems and/or disadvantages and to provide at least the advantages described below. Accordingly, an aspect of exemplary embodiments of the present invention is to provide an apparatus and method for allocating a channel for a retransmission packet based on CQIs in a wireless communication system.

Another aspect of exemplary embodiments of the present invention provides an apparatus and method for allocating a channel for a retransmission packet based on CQIs, when a transmitter changes packet channels in a wireless communication system.

A further aspect of exemplary embodiments of the present invention provides an apparatus and method for allocating a channel in the best state for a retransmission packet, when a transmitter changes packet channels in a wireless communication system.

Still another aspect of exemplary embodiments of the present invention provides an apparatus and method for allocating a channel in the poorest state for a retransmission packet, when a transmitter changes packet channels in a wireless communication system.

Yet another aspect of exemplary embodiments of the present invention provides an apparatus and method for allocating a channel in a similar state to a channel that has delivered an original packet for a retransmission packet, when a transmitter changes packet channels in a wireless communication system.

In accordance with an aspect of exemplary embodiments of the present invention, there is provided a retransmission method in a wireless communication system, in which it is determined whether a retransmission signal exists, when channels for transmitting signals are changed to new channels, a channel is allocated to the retransmission signal, taking into account state information about the new channels, when the retransmission signal exists, and the retransmission signal is transmitted on the allocated channel.

In accordance with another aspect of exemplary embodiments of the present invention, there is provided a retransmission apparatus in a wireless communication system, in which a signal processor selectively outputs an original signal or a retransmission signal according to a signal received from a receiver, indicating whether a transmitted signal has an error, and when channels for transmitting signals are changed to new channels and the signal processor transmits a retransmission signal, a retransmission channel allocator selects a channel for the retransmission signal, taking into account state information about the new channels and allocates the selected channel to the retransmission signal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a retransmission apparatus in a conventional wireless communication system;

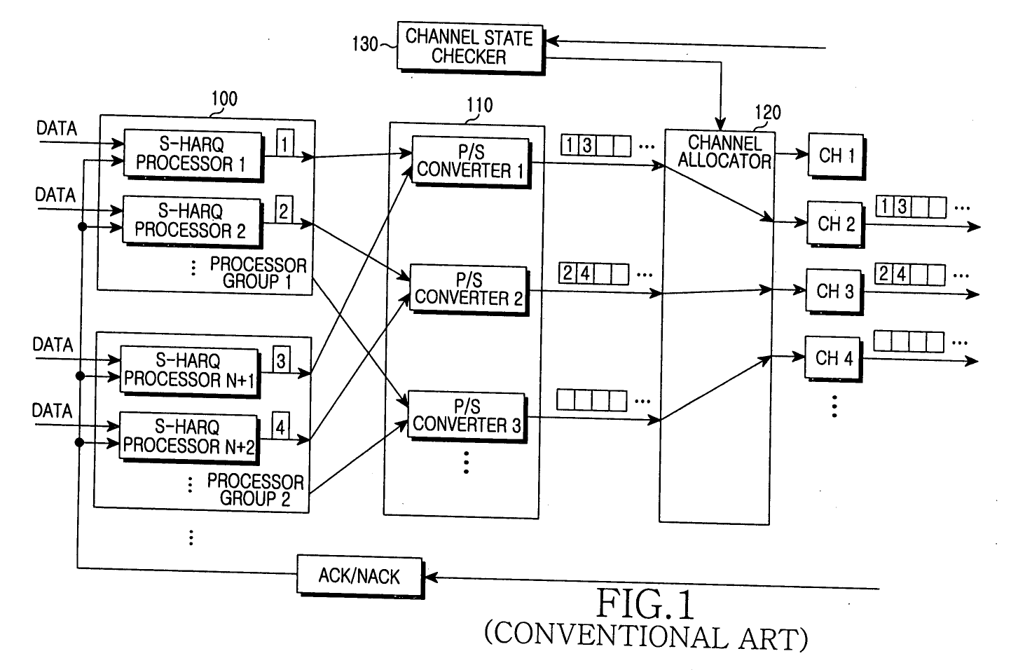

FIG. 2 is a block diagram of a retransmission apparatus in a wireless communication system according to the present invention;

FIG. 3 is a flowchart of an operation for allocating a channel for a retransmission packet in the wireless communication system according to an exemplary embodiment of the present invention;

FIG. 4 is a flowchart of an operation for allocating a channel for a retransmission packet in the wireless communication system according to another exemplary embodiment of the present invention;

FIG. 5 is a flowchart of an operation for allocating a channel for a retransmission packet in the wireless communication system according to a third exemplary embodiment of the present invention; and

FIGS. 6A and 6B illustrate packet channels in the wireless communication system according to an exemplary embodiment of the present invention.

### DETAILED DESCRIPTION OF THE INVENTION

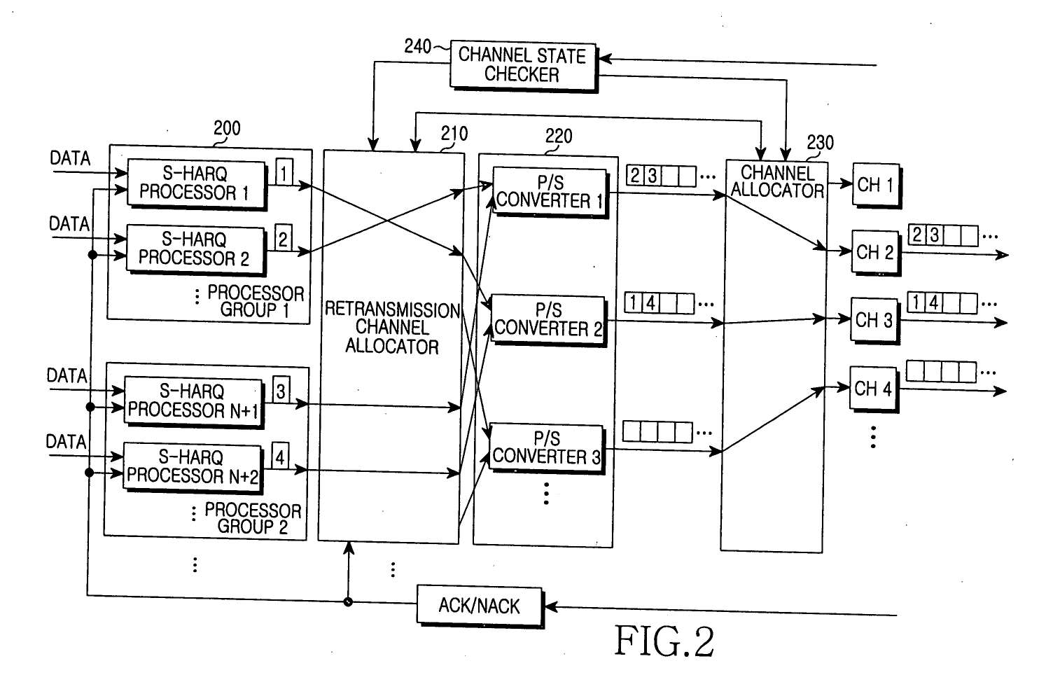

FIGS. 2 through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Exemplary embodiments of the present invention provide a technique for allocating a channel for retransmitting a packet, taking a CQI into account, when a transmitter changes packet channels in a wireless communication system.

If the wireless communication system uses synchronous HARQ, the transmitter sets the transmission timing and channel of a retransmission packet to those of the original version of the retransmission packet.

If the transmitter changes packet channels, it sets the transmission timing of a retransmission packet to that of the original version of the retransmission packet. Notably, the transmitter selects a channel for the retransmission packet based on the CQIs of the changed packet channels. For instance, if the transmitter is configured as illustrated in FIG. 2 and changes packet channels, it selects a channel for the retransmission packet based on the CQIs of the changed packet channels.

FIG. 2 is a block diagram of a retransmission apparatus in the wireless communication system according to the present invention.

Referring to FIG. 2, the transmitter includes processor groups 200, a retransmission channel allocator 210, a P/S converter unit 220, a channel allocator 230, and a channel state checker 240.

Each processor group 200 has HARQ processors for handling transmission or retransmission of packets received from a higher layer according to the packet transmission timing of the processor group 200.

Upon receipt of an ACK signal from a receiver, an HARQ processor processes a new original packet received from the higher layer, for transmission to the receiver at the packet transmission timing of the processor group 200 to which the HARQ processor belongs. Upon receipt of a NACK signal from the receiver, the HARQ processor processes an erroneous packet corresponding to the NACK signal to be retransmitted to the receiver.

When the transmitter changes packet channels, the retransmission channel allocator 210 selects a channel for the retransmission packet according to the CQIs of the changed packet channels selected by the channel allocator 230. The retransmission channel allocator 210 acquires the CQIs of the packet channels from the channel state checker 240.

For example, for the retransmission packet, the retransmission channel allocator 210 selects a channel in the best state from among the packet channels selected by the channel allocator 230 according to the CQIs of the packet channels.

It can be further contemplated as another exemplary embodiment of the present invention that the retransmission channel allocator 210 selects a channel in the poorest state from among the packet channels selected by the channel allocator 230 according to the CQIs of the packet channels.

It can be further contemplated as a third exemplary embodiment of the present invention that the retransmission channel allocator 210 selects a channel in a similar state to a channel that has delivered the original packet from among the packet channels selected by the channel allocator 230 according to the CQIs of the packet channels.

Upon receipt of a channel change signal from the channel allocator 230, the retransmission channel allocator 210 operates to select a channel for the retransmission packet. Hence, the retransmission channel allocator 210 is not operative when an original packet is transmitted or when the transmitter does not change packet channels.

The P/S converter unit 220 converts packets received through the retransmission channel allocator 210 to serial signals. For example, a first P/S converter serializes packets received from a first HARQ processor of a first processor group (processor group 1) and a first HARQ processor of a second processor group (processor group 2).

The channel allocator 230 allocates packets received from the P/S converter unit 220 to channels selected according to channel information received from the channel state checker 240. To transmit a packet in a channel state-based fashion using the channel information received from the channel state checker 240, the channel allocator 230 selects a plurality of channels for packet transmission.

The channel state checker 230 may change the packet channels according to the channel information received from the channel state checker 240. Then, the channel allocator 230 notifies the retransmission channel allocator 210 of the change of the packet channels.

The channel state checker 240 checks channel information between the transmitter and receivers and provides the channel information to the channel allocator 230 and the retransmission channel allocator 210. For example, the channel information can be checked from CQIs fed back from the receivers.

A description will be made of a method for selecting and allocating a channel for a retransmission packet in the retransmission channel allocator 210 of the transmitter. For a retransmission packet, the retransmission channel allocator 210 can select a channel in the best state, in the poorest state, or in a similar state to a channel that has delivered the original version of the retransmission packet.

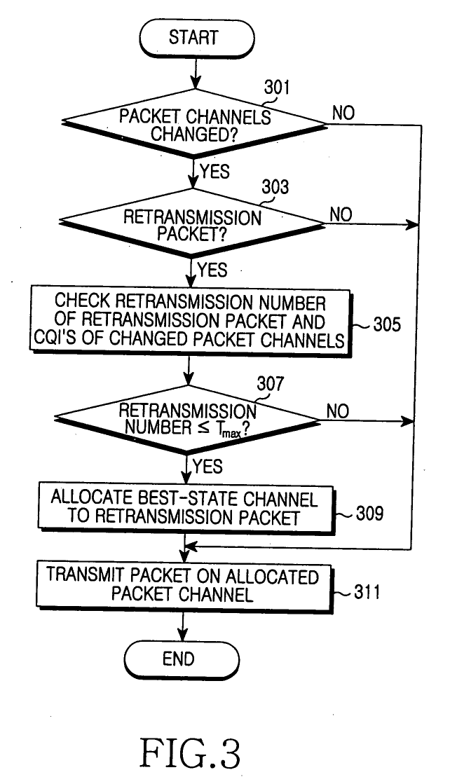

In the case where the retransmission channel allocator 210 selects a channel in the best state for a retransmission packet from among changed packet channels selected by the channel allocator 230, it operates as illustrated in FIG. 3.

FIG. 3 is a flowchart of an operation for allocating a channel for a retransmission packet in the wireless communication system according to an exemplary embodiment of the present invention.

Referring to FIG. 3, the transmitter determines whether packet channels have been changed in step 301.

If the packet channels have not been changed, the transmitter allocates a packet channel to an original packet or a retransmission packet and transmits the original packet or the retransmission packet on the packet channel in step 311. For instance, in the case of an original packet, the transmitter selects a packet channel for the original packet, taking into account the CQIs of the packet channels. In the case of a retransmission packet, the transmitter selects the channel that has carried the original version of the retransmission packet, for the retransmission packet.

Meanwhile, if the packet channels have been changed, the transmitter determines whether an original packet or a retransmission packet is to be transmitted in step 303.

If an original packet is to be transmitted, the transmitter selects a packet channel for the original packet, taking into account the CQIs of the changed packet channels, allocates the selected channel to the original packet, and transmits it in step 311.

On the other hand, if a retransmission packet is to be transmitted, the transmitter checks the retransmission number of the retransmission packet and the CQIs of the changed packet channels in step 305.

In step 307, the transmitter determines whether to transmit the retransmission packet. If the wireless communication system uses ARQ, the transmitter retransmits a packet up to a predetermined number of times. Therefore, the transmitter compares the retransmission number of the retransmission packet with a maximum allowed retransmission number (Tmax) in step 307.

If the retransmission number of the retransmission packet is larger than the maximum allowed retransmission number (retransmission number>Tmax), the transmitter selects a packet channel for a new original packet different from the original version of the retransmission packet, taking into account the CQIs of the changed packet channels, considering that the retransmission packet cannot be transmitted, allocates the selected packet channel to the new original packet, and transmits it in step 311.

If the retransmission number of the retransmission packet is less than or equal to the maximum allowed retransmission number (retransmission number≦Tmax), the transmitter selects a packet channel in the best state for the retransmission packet from among the changed packet channels and allocates the packet channel to the retransmission packet in step 309. The transmitter sets the same MCS level of the original version for the retransmission packet. Therefore, when the packet channel of the retransmission packet is better than that of the original version, the retransmission packet has a decreased error rate, thereby decreasing a retransmission number.

The MCS level of the retransmission packet is fixed according to the channel state of the channel that has delivered the original version. Therefore, if a poorer channel than the channel of the original version is allocated to the retransmission packet, the error rate of the retransmission packet is increased. That is why the transmitter allocates a channel in the best state to a retransmission packet and a channel in a poor state to an original packet. That is, since the transmitter determines an MCS level for the original packet according to channel states, it can decrease the error rate.

After the channel allocation to the retransmission packet, the transmitter transmits the retransmission packet on the allocated packet channel in step 311.

Then, the transmitter ends the algorithm.

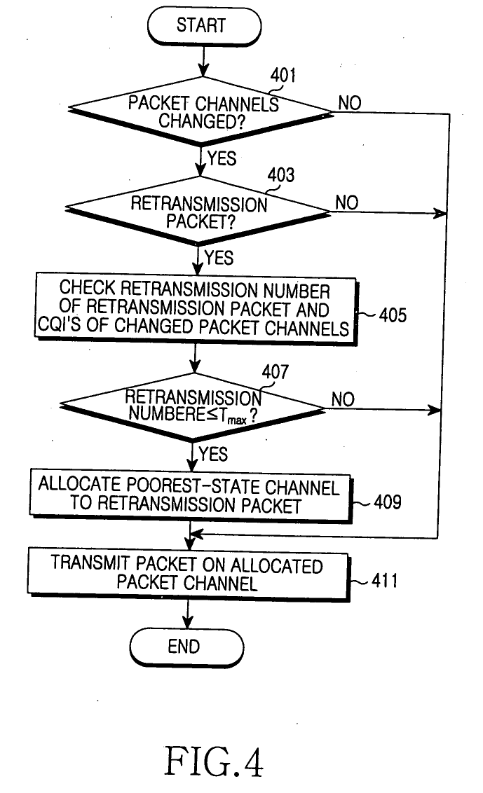

In the case where the retransmission channel allocator 210 selects a channel in the poorest state for a retransmission packet from among changed packet channels selected by the channel allocator 230, it operates as illustrated in FIG. 4.

FIG. 4 is a flowchart of an operation for allocating a channel for a retransmission packet in the wireless communication system according to another exemplary embodiment of the present invention.

Referring to FIG. 4, the transmitter determines whether packet channels have been changed in step 401.

If the packet channels have not been changed, the transmitter allocates a packet channel to an original packet or a retransmission packet and transmits the original packet or the retransmission packet on the packet channel in step 411. For instance, in the case of an original packet, the transmitter selects a packet channel for the original packet, taking into account the CQIs of the packet channels. In the case of a retransmission packet, the transmitter selects the channel that has carried the original version of the retransmission packet, for the retransmission packet.

Meanwhile, if the packet channels have been changed, the transmitter determines whether an original packet or a retransmission packet is to be transmitted in step 403.

If an original packet is to be transmitted, the transmitter selects a packet channel for the original packet, taking into account the CQIs of the changed packet channels, allocates the selected channel to the original packet, and transmits it in step 411.

On the other hand, if a retransmission packet is to be transmitted, the transmitter checks the retransmission number of the retransmission packet and the CQIs of the changed packet channels in step 405.

In step 407, the transmitter determines whether to transmit the retransmission packet. If the wireless communication system uses ARQ, the transmitter retransmits a packet up to a predetermined number of times. Therefore, the transmitter compares the retransmission number of the retransmission packet with a maximum allowed retransmission number (Tmax) in step 407.

If the retransmission number of the retransmission packet is larger than the maximum allowed retransmission number (retransmission number>Tmax), the transmitter selects a packet channel for a new original packet different from the original version of the retransmission packet, taking into account the CQIs of the changed packet channels, considering that the retransmission packet cannot be transmitted, allocates the selected packet channel to the new original packet, and transmits it in step 411.

If the retransmission number of the retransmission packet is less than or equal to the maximum allowed retransmission number (retransmission number≦Tmax), the transmitter selects a packet channel in the poorest state for the retransmission packet from among the changed packet channels and allocates the selected packet channel to the retransmission packet in step 409.

The transmitter sets the same MCS level of the original version for the retransmission packet. If the packet channel of the retransmission packet is better than that of the original version, the retransmission packet may have a decreased throughput. As the transmitter allocates a channel in a good state to an original packet and a channel in a poor state to a retransmission packet, it can increase the throughput.

After the channel allocation to the retransmission packet, the transmitter transmits the retransmission packet on the allocated packet channel in step 411.

Then, the transmitter ends the algorithm.

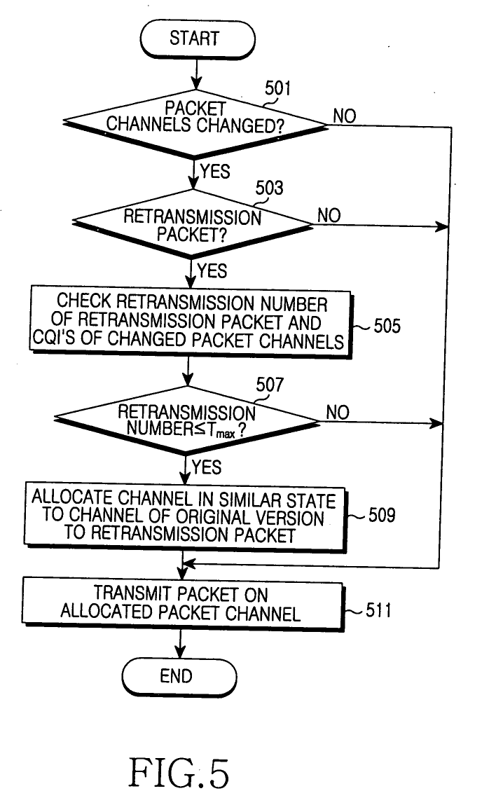

In the case where for a retransmission packet, the retransmission channel allocator 210 selects a channel in a similar state to the channel that has delivered the original version of the retransmission packet from among changed packet channels selected by the channel allocator 230, it operates as illustrated in FIG. 5.

FIG. 5 is a flowchart of an operation for allocating a channel for a retransmission packet in the wireless communication system according to a third exemplary embodiment of the present invention.

Referring to FIG. 5, the transmitter determines whether packet channels have been changed in step 501.

If the packet channels have not been changed, the transmitter allocates a packet channel to an original packet or a retransmission packet and transmits the original packet or the retransmission packet on the packet channel in step 511. For instance, in the case of an original packet, the transmitter selects a packet channel for the original packet, taking into account the CQIs of the packet channels. In the case of a retransmission packet, the transmitter selects the channel that has carried the original version of the retransmission packet, for the retransmission packet.

Meanwhile, if the packet channels have been changed, the transmitter determines whether an original packet or a retransmission packet is to be transmitted in step 503.

If an original packet is to be transmitted, the transmitter selects a packet channel for the original packet, taking into account the CQIs of the changed packet channels, allocates the selected channel to the original packet, and transmits it in step 511.

On the other hand, if a retransmission packet is to be transmitted, the transmitter checks the retransmission number of the retransmission packet and the CQIs of the changed packet channels in step 505.

In step 507, the transmitter determines whether to transmit the retransmission packet. If the wireless communication system uses ARQ, the transmitter retransmits a packet up to a predetermined number of times. Therefore, the transmitter compares the retransmission number of the retransmission packet with a maximum allowed retransmission number (Tmax) in step 507.

If the retransmission number of the retransmission packet is larger than the maximum allowed retransmission number (retransmission number>Tmax), the transmitter selects a packet channel for a new original packet different from the original version of the retransmission packet, taking into account the CQIs of the changed packet channels, considering that the retransmission packet cannot be transmitted, allocates the selected packet channel to the new original packet, and transmits it in step 511.

If the retransmission number of the retransmission packet is less than or equal to the maximum allowed retransmission number (retransmission number≦Tmax), for the retransmission packet, the transmitter selects a packet channel in a similar state to the channel that has delivered the original version of the retransmission packet from among the changed packet channels and allocates the selected packet channel to the retransmission packet in step 509. The transmitter sets the same MCS level of the original version for the retransmission packet. Therefore, for the retransmission packet, the transmitter selects a packet channel in a similar state to the packet channel that has delivered the original version of the retransmission packet from among the changed packet channels.

After the channel allocation to the retransmission packet, the transmitter transmits the retransmission packet on the allocated packet channel in step 511.

Then, the transmitter ends the algorithm.

Now a channel allocation mechanism for a retransmission packet in the transmitter of the wireless communication system will be described below.

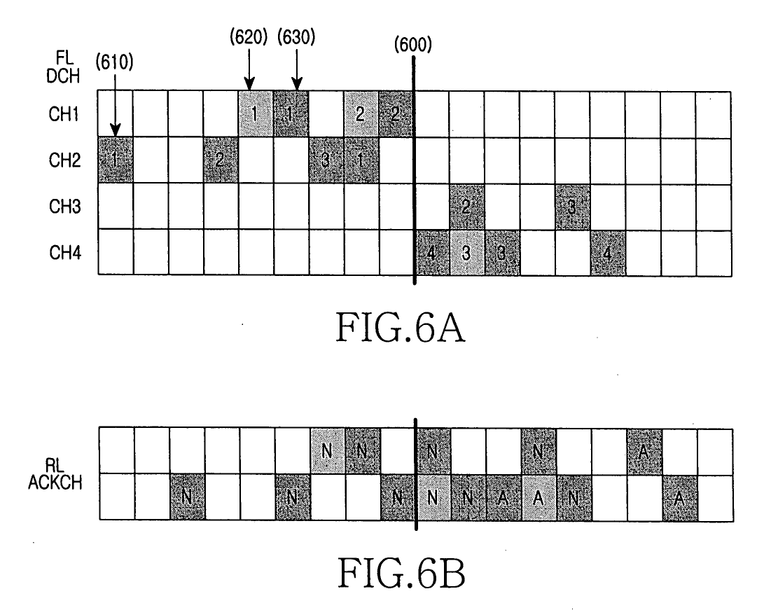

FIGS. 6A and 6B illustrate packet channels in the wireless communication system according to an exemplary embodiment of the present invention. Specifically, FIG. 6A illustrates the packet channels and FIG. 6B illustrates ACK/NACK signals fed back from receivers.

The transmitter transmits packets on a first channel (CH1) and a second channel (CH2) as illustrated in FIG. 6A and receives ACK/NACK signals on ACK CHannels (ACKCHs) as illustrated in FIG. 6B. For example, upon receipt of an ACK signal on an ACKCH, the transmitter transmits an original packet on CH1 or CH2. Upon receipt of a NACK signal on an ACKCH, the transmitter transmits a retransmission packet of an original packet corresponding to the NACK signal on CH1 or CH2 that has delivered the original packet.

When the transmitter changes from CH1 and CH2 to third and fourth channels (CH3 and CH4) at time 600, it selects a packet channel for an original packet according to the state information of CH3 and CH4 and transmits the original packet on the selected packet channel.

Upon receipt of a NACK signal for a packet transmitted before the channel change on an ACKCH illustrated in FIG. 6B, the transmitter selects a channel between CH3 and CH4 for a retransmission packet of the packet corresponding to the NACK signal according to the state information of CH3 and CH4. For example, the selected channel is the better-state channel between CH3 and CH4. It can be further contemplated as another exemplary embodiment of the present invention that the selected channel is the poorer-state channel between CH3 and CH4.

It can be further contemplated as a further exemplary embodiment of the present invention that the selected channel is a channel in a similar state to the channel that has delivered the original version of the retransmission packet, between CH3 and CH4.

As described above, when packet channels are changed in the wireless communication system, the transmitter selects a packet channel for a retransmission packet of a packet transmitted before the channel change from among the changed packet channels, taking into account the state information of the changed packet channels.

The transmitter can prioritize retransmission packets according to their retransmission numbers, for selecting packet channels for the retransmission packets. For example, the transmitter may give a higher priority level to a retransmission packet with a higher retransmission number. In this case, the transmitter allocates a packet channel to a retransmission packet with the highest retransmission number, first of all.

In another exemplary embodiment of the present invention, the transmitter can give a higher priority level to a retransmission packet with a lower retransmission number. In this case, the transmitter puts original packets in the first place in channel allocation, followed by a retransmission packet with the lowest retransmission number.

As is apparent from the above description of the present invention, when a transmitter changes packet channels in a wireless communication system, it allocates a packet channel for a retransmission packet, taking into account the state information of the changed packet channels. The resulting decrease in the retransmission number of the retransmission packet reduces a transmission time delay and increases the throughput of the transmitter.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A retransmission method in a wireless communication system, comprising:
determining whether a retransmission signal exists, when channels for transmitting signals are changed to new channels;
allocating a channel to the retransmission signal, taking into account state information about the new channels, when the retransmission signal exists; and
transmitting the retransmission signal on the allocated channel.

2. The retransmission method of claim 1, wherein the retransmission signal is a retransmission version of a signal transmitted to a receiver before the channels are changed to the new channels.

3. The retransmission method of claim 1, wherein the channel allocation comprises:
selecting a channel in a best channel state from among the new channels; and
allocating the selected channel to the retransmission signal.

4. The retransmission method of claim 1, wherein the channel allocation comprises:
selecting a channel in a poorest channel state from among the new channels; and
allocating the selected channel to the retransmission signal.

5. The retransmission method of claim 1, wherein the channel allocation comprises:
selecting a channel in a similar state to a channel that has carried an original version of the retransmission signal from among the new channels; and
allocating the selected channel to the retransmission signal.

6. The retransmission method of claim 1, wherein the channel allocation comprises;
prioritizing, if at least one retransmission signal exists, the at least one retransmission signal; and
allocating a channel to the at least one retransmission signal in a descending order of priority levels, taking into account the state information about the new channels.

7. The retransmission method of claim 6, wherein the prioritization comprises prioritizing the at least one retransmission signal according to a retransmission number of the at least one retransmission signal.

8. The retransmission method of claim 1, wherein the state information about the new channels are determined from Channel Quality Indications (CQIs) included in signals fed back from a receiver.

9. The retransmission method of claim 1, further comprising, if the retransmission signal exists:
checking a retransmission number of the retransmission signal; and
determining whether to transmit the retransmission signal according to the retransmission number,
wherein if it is determined to transmit the retransmission signal, the channel is allocated to the retransmission signal.

10. The retransmission method of claim 9, further comprising, if no retransmission signal exists, allocating a channel to a new original signal different from the original version of the retransmission signal and transmitting the new original signal on the allocated channel.

11. A retransmission apparatus in a wireless communication system, comprising:
a signal processor for selectively outputting an original signal or a retransmission signal according to a signal received from a receiver, indicating whether a transmitted signal has an error; and
a retransmission channel allocator for when channels for transmitting signals are changed to new channels and the signal processor transmits a retransmission signal, selecting a channel for the retransmission signal, taking into account state information about the new channels and allocating the selected channel to the retransmission signal.

12. The retransmission apparatus of claim 11, wherein the signal processor transmits the original signal, upon receipt of an ACKnowledgment (ACK) signal from the receiver, and transmits a retransmission signal upon receipt of a Negative ACK (NACK) signal from the receiver.

13. The retransmission apparatus of claim 11, further comprising a channel state checker for checking state information about the channels from a signal fed back from the receiver.

14. The retransmission apparatus of claim 11, wherein when the channels for transmitting signals are changed to the new channels and the signal processor outputs the retransmission signal, the retransmission channel allocator selects the channel for the retransmission signal, taking into account the state information about the new channels.

15. The retransmission apparatus of claim 11, wherein the retransmission channel allocator allocates the retransmission signal to a channel in a best channel state among the new channels.

16. The retransmission apparatus of claim 11, wherein the retransmission channel allocator allocates the retransmission signal to a channel in a poorest channel state among the new channels.

17. The retransmission apparatus of claim 11, wherein the retransmission channel allocator allocates the retransmission signal to a channel in a similar channel state to a channel that has transmitted an original version of the retransmission signal among the new channels.

18. The retransmission apparatus of claim 11, wherein when the signal processor outputs at least one retransmission signal, the retransmission channel allocator prioritizes the at least one retransmission signal and allocates a channel to the at least one retransmission signal in a descending order of priority levels.

19. The retransmission apparatus of claim 18, wherein the retransmission channel allocator prioritizes the at least one retransmission signal according to a retransmission number of the at least one retransmission signal.

20. The retransmission apparatus of claim 11, further comprising a channel allocator for allocating a channel to the original signal or the retransmission signal output by the signal processor, wherein when the signal processor outputs an original signal or the channel for transmitting signals are not changed to the new channels, the retransmission channel allocator relays a signal received from the signal processor to the channel allocator.
